(19) United States
(12) Patent Application Publication
(10) Pub. No.: US 2024/0255933 A1
(43) Pub. Date: Aug. 1, 2024

(54) Device for Clustering-based Labeling, Device for Anomaly Detection, and Methods therefor

(71) Applicant: SK Planet Co., Ltd., Seongnam-si (KR)

(72) Inventor: Yeonghyeon PARK, Cheonan-si (KR)

(21) Appl. No.: 18/633,453

(22) Filed: Apr. 11, 2024

Related U.S. Application Data
(63) Continuation of application No. PCT/KR2022/017411, filed on Nov. 8, 2022.

(30) Foreign Application Priority Data
Nov. 9, 2021 (KR) 10-2021-0153391
Nov. 22, 2021 (KR) 10-2021-0161700

(51) Int. Cl. G05B 19/418

(52) U.S. Cl. CPC G05B 19/41875; G05B 2219/32368

(57) ABSTRACT

A method for labeling comprises: a clustering unit forms a plurality of nodes, upon the input of a plurality of pieces of data, by projecting the plurality of pieces of input data onto a predetermined vector space; the clustering unit generates clusters by clustering the plurality of nodes; a labeling unit carries out connected component analysis of the generated clusters to derive one or more connected components; and the labeling unit labels the connected components. In addition, an anomaly detection method based on clustering of the present invention comprises the step in which a detecting unit determines whether difference between a mock data cluster and an input data cluster is equal to or greater than a preset threshold value and, if the difference is determined to be equal to or greater than a preset threshold value, determines that there is an anomaly in the input data cluster.

### CROSS-REFERENCE TO RELATED APPLICATIONS

This application is a bypass continuation of International PCT application No. PCT/KR2022/017411, filed on Nov. 8, 2022, which claims priority to Republic of Korea Patent Application No. 10-2021-0153391, filed on Nov. 9, 2021, and Republic of Korea Patent Application No. 10-2021-0161700 filed on Nov. 22, 2021, which are incorporated by reference herein in their entirety.

### TECHNICAL FIELD

The present invention relates to labeling technology, and more particularly, to a device and method for automatically performing labeling based on clustering and performing anomaly detection based on clustering.

### BACKGROUND ART

In the smart factory field, the number of cases of introducing machine learning or deep learning techniques to improve work efficiency is increasing. As a representative example, manufacturers sometimes introduce this method for the purpose of speeding up and automating the determination of good/defective products. This conventional method has a limitation in that it requires a data set containing labels to build a machine learning model to determine good/defective products. Even when assuming the case of constructing a model for an anomaly detection category, it is required to detect data in a normal category and perform labeling. From a manufacturer's perspective, manual labeling of products through total inspection may be a huge burden due to the volume and speed of products being produced.

There is an increasing number of cases of introducing machine learning or deep learning techniques to improve work efficiency. As a representative example, manufacturers sometimes introduce this method for the purpose of speeding up and automating the determination of good/defective products. This conventional method has a limitation in that it requires a data set containing labels to build a machine learning model to determine good/defective products. Even when assuming the case of constructing a model for an anomaly detection category, it is required to detect data in a normal category and perform labeling. From a manufacturer's perspective, manual labeling of products through total inspection may be a huge burden due to the volume and speed of products being produced, so a fundamental solution is required.

### SUMMARY

One object of the present invention is to provide a device and method for minimizing labeling time and cost by performing labeling based on clustering.

Another object of the present invention is to provide a device and method for anomaly detection based on clustering.

According to an embodiment of the present invention, a method for performing labeling includes, by a cluster unit, upon receiving a plurality of input data, forming a plurality of nodes by mapping the plurality of input data into a predetermined vector space; by the cluster unit, creating a cluster by clustering the plurality of nodes; by a label processor, deriving one or more connected components by performing connected component analysis on the created cluster; and by the label processor, performing labeling on the connected components.

Creating the cluster by clustering the plurality of nodes may include, by the cluster unit, calculating a node value of a node in the cluster and an edge value indicating a distance or correlation between one node and another node.

Performing labeling on the connected components may include, by the label processor, determining a label for the connected component based on an average of edge values between the plurality of nodes included in the connected component.

In one embodiment, in case where the edge value represents a distance between nodes in the vector space, determining the label may include, by the label processor, assigning the label of the connected component with a lowest average of edge values between the nodes included in the connected component as normal.

In another embodiment, in case where the edge value represents a correlation between nodes in the vector space, determining the label may include, by the label processor, assigning the label of the connected component with a highest average of edge values between the nodes included in the connected component as normal.

According to an embodiment of the present invention, a device for performing labeling includes a cluster unit, upon receiving a plurality of input data, forming a plurality of nodes by mapping the plurality of input data into a predetermined vector space, and creating a cluster by clustering the plurality of nodes; and a label processor deriving one or more connected components by performing connected component analysis on the created cluster, and performing labeling on the connected components.

The cluster unit may calculate a node value of a node in the cluster and an edge value indicating a distance or correlation between one node and another node.

The label processor may determine a label for the connected component based on an average of edge values between the plurality of nodes included in the connected component.

In one embodiment, in case where the edge value represents a distance between nodes in the vector space, the label processor may assign the label of the connected component with a lowest average of edge values between the nodes included in the connected component as normal.

In another embodiment, in case where the edge value represents a correlation between nodes in the vector space, the label processor may assign the label of the connected component with a highest average of edge values between the nodes included in the connected component as normal.

According to another embodiment of the present invention, a method for anomaly detection includes, by a cluster unit, creating a data cluster by clustering accumulated data whenever a predetermined first number of input data are accumulated; by a detection unit, inputting the data cluster into a detection network trained to simulate the data cluster; when the detection network reconstructs the data cluster and creates a simulated data cluster simulating the data cluster, by the detection unit, determining whether a difference between the simulated data cluster and the input data cluster is greater than or equal to a predetermined threshold; and upon determining that the difference is greater than or equal to the predetermined threshold, determining that there is an anomaly in the input data cluster.

The method may further include, upon determining that the difference is less than the predetermined threshold, by the cluster unit, erasing a predetermined second number of data from the data cluster; by the cluster unit, creating a new data cluster by accumulating newly input data into the data cluster from which the predetermined second number of data are erased; and by the detection unit, detecting an anomaly in the new created data cluster by using the detection network.

The method may further include, before creating the data cluster, by the cluster unit, creating a data cluster for learning by accumulating a predetermined first number of data and clustering the accumulated data; by a learning unit, inputting the data cluster for learning into an unlearned detection network; by the detection network, reconstructing the data cluster for learning and thereby creating a simulated data cluster for learning that simulates the data cluster for learning; and by the learning unit, performing optimization to update a parameter of the detection network so that a difference between the simulated data cluster for learning and the input data cluster for learning is minimized.

Data contained in the data cluster for learning may include normal data and abnormal data. In addition, the number of abnormal data included in the data cluster for learning may be less than a predetermined ratio (ab) to the number of normal data included in the data cluster for learning.

According to another embodiment of the present invention, a device for anomaly detection includes a cluster unit creating a data cluster by clustering accumulated data whenever a predetermined first number of input data are accumulated; and a detection unit inputting the data cluster into a detection network trained to simulate the data cluster, when the detection network reconstructs the data cluster and creates a simulated data cluster simulating the data cluster, determining whether a difference between the simulated data cluster and the input data cluster is greater than or equal to a predetermined threshold, and upon determining that the difference is greater than or equal to the predetermined threshold, determining that there is an anomaly in the input data cluster.

The cluster unit may erase a predetermined second number of data from the data cluster upon determining that the difference is less than the predetermined threshold, and create a new data cluster by accumulating newly input data into the data cluster from which the predetermined second number of data are erased. The detection unit may detect an anomaly in the new created data cluster by using the detection network.

The device may further include a learning unit inputting, when the cluster unit creates a data cluster for learning by accumulating a predetermined first number of data and clustering the accumulated data, the data cluster for learning into an unlearned detection network, and performing, when the detection network reconstructs the data cluster for learning and thereby creates a simulated data cluster for learning that simulates the data cluster for learning, optimization to update a parameter of the detection network so that a difference between the simulated data cluster for learning and the input data cluster for learning is minimized.

Data contained in the data cluster for learning may include normal data and abnormal data. In addition, the number of abnormal data included in the data cluster for learning may be less than a predetermined ratio (ab) to the number of normal data included in the data cluster for learning.

According to the present invention, labeling can be performed automatically or semi-automatically based on clustering. It is therefore possible to reduce the burden of labeling costs and time when creating a model that classifies good and defective products or classifies production conditions of good and defective products.

According to another embodiment of the present invention, it is possible to create a learning model, that is, a detection network, capable of detecting whether there is an anomaly without labeling by using an extremely large amount of data. It is therefore possible to save time, effort, and cost in creating the learning model. In addition, traceability can be improved by detecting an anomaly using the detection network.

### BRIEF DESCRIPTION OF DRAWINGS

FIG. 1 is a diagram illustrating the configuration of a device for performing labeling based on clustering according to an embodiment of the present invention.

FIG. 2 is a diagram illustrating the detailed configuration of a device for performing labeling based on clustering according to an embodiment of the present invention.

FIG. 3 is a flowchart illustrating a method for performing labeling based on clustering according to an embodiment of the present invention.

FIG. 4 is a diagram illustrating a method for performing labeling based on clustering according to an embodiment of the present invention.

FIG. 5 is a diagram illustrating the configuration of a device for anomaly detection based on clustering according to another embodiment of the present invention.

FIG. 6 is a diagram illustrating the detailed configuration of a device for anomaly detection based on clustering according to another embodiment of the present invention.

FIG. 7 is a diagram illustrating the configuration of a detection network for anomaly detection based on clustering according to another embodiment of the present invention.

FIG. 8 is a flowchart illustrating a method for training a detection network for anomaly detection based on clustering according to another embodiment of the present invention.

FIG. 9 is a diagram illustrating clustering data for training a detection network for anomaly detection based on clustering according to another embodiment of the present invention.

FIG. 10 is a flowchart illustrating a method for anomaly detection based on clustering according to another embodiment of the present invention.

### DETAILED DESCRIPTION OF EMBODIMENTS

In order to clarify the features and advantages of the technical solution of the present invention, the present invention will be described in detail through specific embodiments of the present invention with reference to the accompanying drawings.

However, in the following description and the accompanying drawings, well known techniques may not be described or illustrated to avoid obscuring the subject matter of the present invention. Through the drawings, the same or similar reference numerals denote corresponding features consistently.

The terms and words used in the following description, drawings and claims are not limited to the bibliographical meanings thereof and are merely used by the inventor to enable a clear and consistent understanding of the invention. Thus, it will be apparent to those skilled in the art that the following description about various embodiments of the present invention is provided for illustration purpose only and not for the purpose of limiting the invention as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present invention. Also, the terms “comprise”, “include”, “have”, and derivatives thereof refer to inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

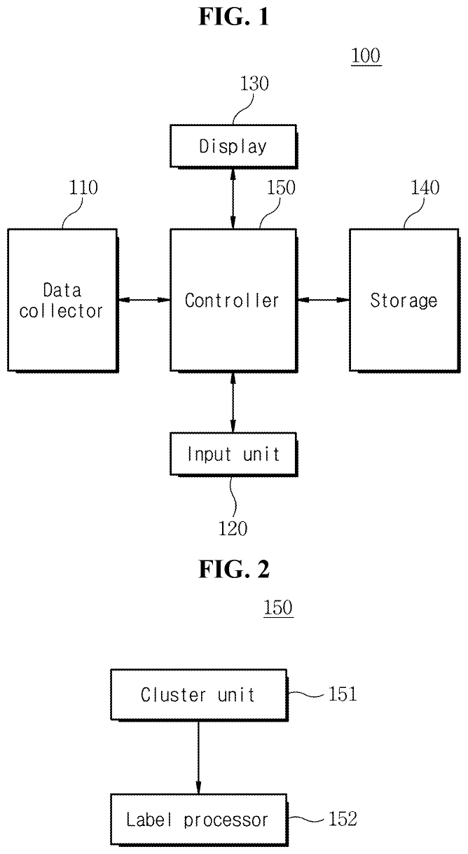

At the outset, a device for performing labeling based on clustering according to an embodiment of the present invention will be described. FIG. 1 is a diagram illustrating the configuration of a device for performing labeling based on clustering according to an embodiment of the present invention. FIG. 2 is a diagram illustrating the detailed configuration of a device for performing labeling based on clustering according to an embodiment of the present invention.

Referring to FIG. 1, a device 100 for performing labeling based on clustering according to an embodiment of the present invention (hereinafter referred to as ‘labeling device’) includes a data collector 110, an input unit 120, a display 130, a storage 140, and a controller 150.

The data collector 110 is for collecting data. Here, the data may be a measurement value obtained by measuring a product produced in a production facility such as a smart factory through a certain sensor to determine whether the produced product is a good product or a defective product. Such data may be, for example, length, weight, shape, degree of withstanding bending or impact, degree of withstanding pressure, elasticity, etc. The data collector 110 may store the collected data in the storage 140 under the control of the controller 150.

The input unit 120 receives a user's key manipulation to control the labeling device 100, generates an input signal, and transmits it to the controller 150. In particular, the input unit 120 may detect a user's input of specifying a label, color, etc. for a connected component and transmit it to the controller 150. The input unit 120 may include one of a power key for powering on/off, a numeric key, and an arrow key, and may be formed as a predetermined function key on one side of the labeling device 100. In the case where the display 130 is formed of a touch screen, the functions of various keys of the input unit 120 may be performed by the display 130, and if all functions can be performed only with a touch screen, the input unit 120 may be omitted.

The display 130 is for screen display and may visually provide a menu of the labeling device 100, input data, function setting information, and any other information to the user. In particular, the display 130 may display a cluster including a plurality of nodes corresponding to a plurality of data on the screen under the control of the controller 150. The display 130 may be formed of a liquid crystal display (LCD), an organic light emitting diode (OLED), an active matrix organic light emitting diode (AMOLED), or the like. Meanwhile, the display 130 may be implemented with a touch screen. In this case, the display 130 includes a touch sensor. The touch sensor detects a user's touch input. The touch sensor may be formed of a touch sensitive sensor of a capacitive overlay type, a pressure type, a resistive overlay type, or an infrared beam type, or may be formed of a pressure sensitive sensor. In addition to the above sensors, all types of sensor devices capable of detecting contact or pressure of an object may be used as the touch sensor of the present invention. The touch sensor may sense a user's touch input, generate a sensing signal including input coordinates indicating a touched location, and transmit it to the controller 150. In this case, the display 130 may detect a user's input of specifying a label, color, etc. for a connected component and transmit it to the controller 150.

The storage 140 serves to store programs and data necessary for the operation of the labeling device 100, and may be divided into a program region and a data region. The program region may store programs for controlling the overall operation of the labeling device 100, an operating system (OS) for booting the labeling device 100, applications, and the like. The data region may store data generated according to the use and operation of the labeling device 100. In particular, data collected by the data collector 110 may be stored. Various kinds of data stored in the storage 140 may be deleted, modified, or added.

The controller 150 controls the overall operation of the labeling device 100 and a signal flow between internal blocks of the labeling device 100, and may perform a data processing function to process data. Basically, the controller 150 controls various functions of the labeling device 100. The controller 150 may include, for example, a central processing unit (CPU), a digital signal processor (DSP), or the like. Referring to FIG. 2, the controller 150 includes a cluster unit 151 and a label processor 152.

The cluster unit 151 creates a data cluster by clustering data. To this end, when a plurality of data are input, the cluster unit 151 forms a plurality of nodes by mapping the plurality of input data into a predetermined vector space. Then, the cluster unit 151 clusters the plurality of nodes in accordance with a predetermined clustering algorithm to create a cluster. Here, the clustering algorithms may include, for example, K-means clustering, Mean-shift clustering, DBSCAN, Expectation-maximization clustering, and Agglomerative Hierarchical Clustering.

The label processor 152 performs connected component analysis on the cluster created by the cluster unit 151 and thereby derives one or more connected components (CC). Then, the label processor 152 performs labeling on the connected components.

The operation of the controller 150 including the cluster unit 151 and the label processor 152 will be described in more detail below.

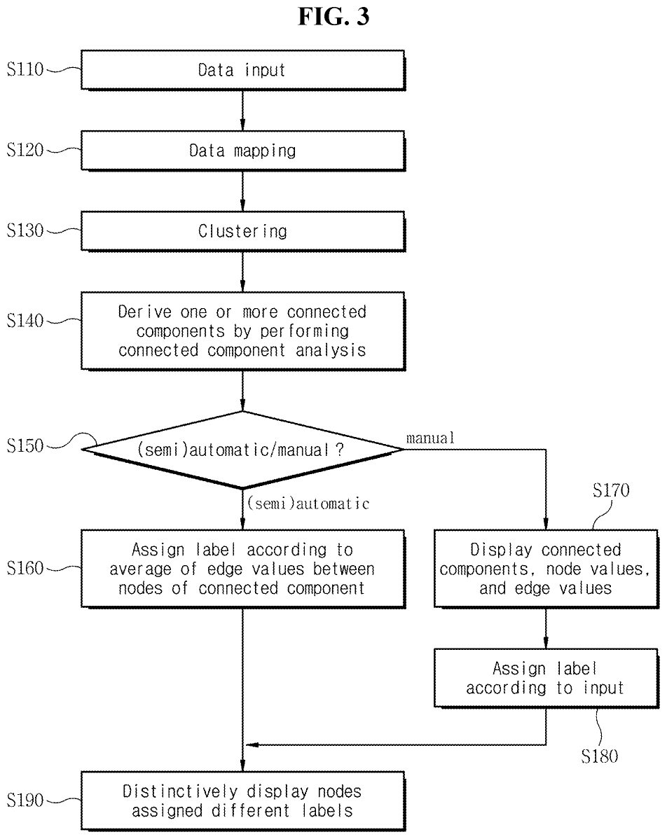

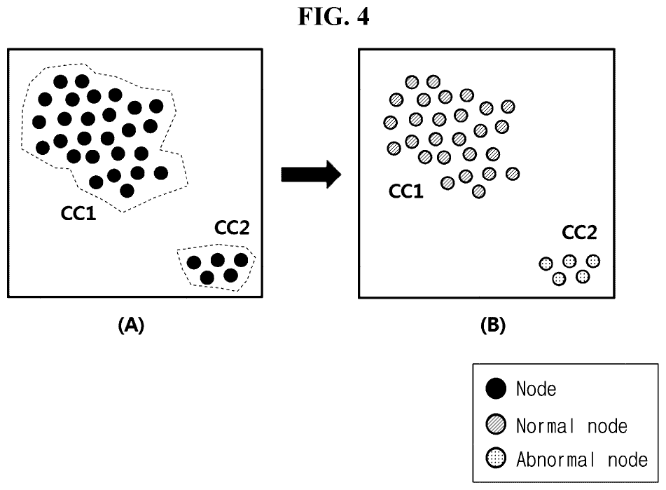

Next, a method for performing labeling based on clustering according to an embodiment of the present invention will be described. FIG. 3 is a flowchart illustrating a method for performing labeling based on clustering according to an embodiment of the present invention. FIG. 4 is a diagram illustrating a method for performing labeling based on clustering according to an embodiment of the present invention.

Referring to FIG. 3, the cluster unit 151 continuously receives a plurality of data in step S110. At this time, the data may be data collected through the data collector 110 or data stored in the storage 140. This data may be a measurement value obtained by measuring a produced product through a certain sensor in order to determine whether the product is good or defective.

When the plurality of data is input, the cluster unit 151 forms a plurality of nodes by mapping the input plurality of data into a predetermined vector space in step S120. For example, the vector space may be a two-dimensional vector space with the length and elasticity of a product as the axes. In addition, the axes constituting the vector space may be composed of measurement values obtained by measuring the produced product with a predetermined sensor in order to determine whether the product is good or defective. These axes may be, for example, length, weight, shape, degree of withstanding bending or impact, degree of withstanding pressure, elasticity, etc.

Next, in step S130, the cluster unit 151 creates a cluster by clustering the plurality of nodes. An example of the created cluster is shown in (A) of FIG. 4. As shown, the plurality of nodes are included in one cluster. According to this clustering, the cluster unit 151 may derive a node value of each of the plurality of nodes in the cluster and an edge value between the nodes. Here, the node value refers to a value in the vector space of the corresponding node, and the edge value denotes a distance or correlation between the nodes.

Next, the label processor 152 performs connected component analysis on the created cluster and thereby derives one or more connected components (CC). In the case of the cluster shown in (A) of FIG. 4, two connected components, that is, a first connected component (CC1) and a second connected component (CC2), may be derived.

Next, in step S150, the label processor 152 determines whether a label mode is an automatic mode that performs labeling automatically or semi-automatically, or a manual mode that performs labeling manually.

In the case where the automatic mode is determined in step S150, step S160 will be performed, and in the case of the manual mode, step S170 will be performed.

In the case of the automatic mode, the label processor 152 determines a label for the connected component (CC) according to an average of edge values between nodes included in the connected component (CC) in step S160, and assigns the determined label. At this time, when the edge value represents a distance between nodes in the vector space, the label processor 152 assigns the label of the connected component (CC) with the lowest average of edge values between the nodes included in the connected component (CC) as normal. In addition, the labels of all the remaining connected components (CC) are assigned as abnormal. In the example of FIG. 4, when the edge value is a distance between nodes in the vector space, the average of the edge values of the first connected component (CC1) is lower than the average of the edge values of the second connected component (CC2). Accordingly, a normal label is assigned to the first connected component (CC1), and an abnormal label is assigned to the second connected component (CC2). That is, labels for a plurality of data corresponding to a plurality of nodes included in the first connected component (CC) are given as ‘normal data’, and labels for a plurality of data corresponding to a plurality of nodes included in the second connected component (CC) are given as ‘abnormal data’.

In addition, when the edge value represents a correlation between nodes in the vector space, the label processor 152 assigns the label of the connected component (CC) with the highest average of edge values between the nodes included in the connected component (CC) as normal. Thus, a label for data corresponding to nodes included in the corresponding connected component (CC) is given as ‘normal’. In addition, the labels of all the remaining connected components (CC) are assigned as abnormal. In the example of FIG. 4, when the edge value is a distance between nodes in the vector space, the average of the edge values of the first connected component (CC1) is higher than the average of the edge values of the second connected component (CC2). Accordingly, a normal label is assigned to the first connected component (CC1), and an abnormal label is assigned to the second connected component (CC2). That is, labels for a plurality of data corresponding to a plurality of nodes included in the first connected component (CC) are given as ‘normal data’, and labels for a plurality of data corresponding to a plurality of nodes included in the second connected component (CC) are given as ‘abnormal data’.

Meanwhile, the above-described step S160 may be executed in a semi-automatic mode. Both the automatic mode and the semi-automatic mode are performed through the same process. However, in the case of the semi-automatic mode, the label processor 152 displays a connected component to be label-assigned and a label to be assigned to the connected component through the display 130 before assigning the label, and performs labeling in response to a user's confirmation input.

In the case of the manual mode, the label processor 152 displays connected components, node values, and edge values through the display 130 in step S170. For example, a screen as shown in (A) of FIG. 4 may be displayed. The user can view the displayed connected components, node values, and edge values, and input a preferred target to be label-assigned and a label (normal/abnormal) through the input unit 120 or the display 130. Then, in step S180, the label processor 152 specifies a label-assigning target in response to the user's input detected through the input unit 120 or the display 130, and assigns the user input label to the specified object.

If the label is assigned as in steps S160 and S180 described above, the label processor 152 distinctively displays nodes assigned different labels in step S190. For example, as shown in (B) of FIG. 4, nodes included in the first connected component (CC1) labeled as normal data may be displayed in a first color (e.g., blue), and nodes included in the second connected component (CC2) labeled as abnormal data may be displayed in a second color (e.g., red).

According to an additional embodiment, a color table that contains a plurality of colors corresponding proportionally to an average of edge values of a plurality of nodes included in the connected component (CC) can be prepared, and a color corresponding to the average of the edge values of the plurality of nodes included in the connected component (CC) can be selected from the prepared color table and displayed as the color for the plurality of nodes included in the connected component (CC). For example, according to the color table, in the case where an edge value represents a correlation between nodes in a vector space, the higher the average of the edge values, the closer a color to the first color (e.g., blue) may be mapped, and the lower the average of the edge values, the closer a color to the second color (e.g., red) may be mapped.

In the case of manufacturing industries that have introduced smart factories, analysis of products according to production conditions is required in an effort to improve yield at the manufacturing stage. If there is a model that classifies good and defective products or classifies the production conditions for good and defective products, it is possible to stop production and repair the equipment or environment in situations where production conditions for defective products occur. However, in order to build such a model, there is the inconvenience of having to perform a total inspection and labeling for production conditions. In order to solve this problem, the present invention automatically collects data on production conditions or products and performs labeling semi-automatically, thereby reducing the burden of labeling costs and time when creating a model that classifies good and defective products or classifies production conditions of good and defective products.

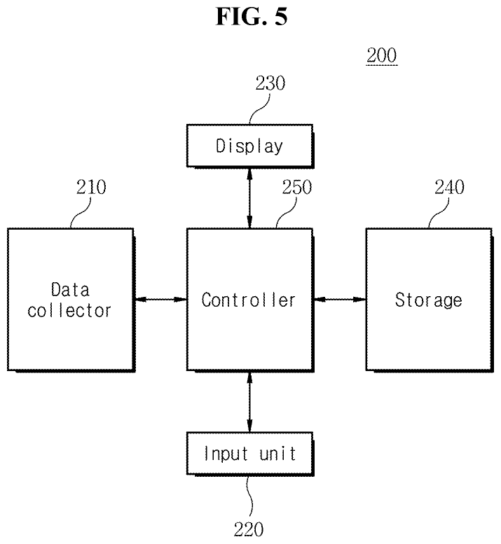

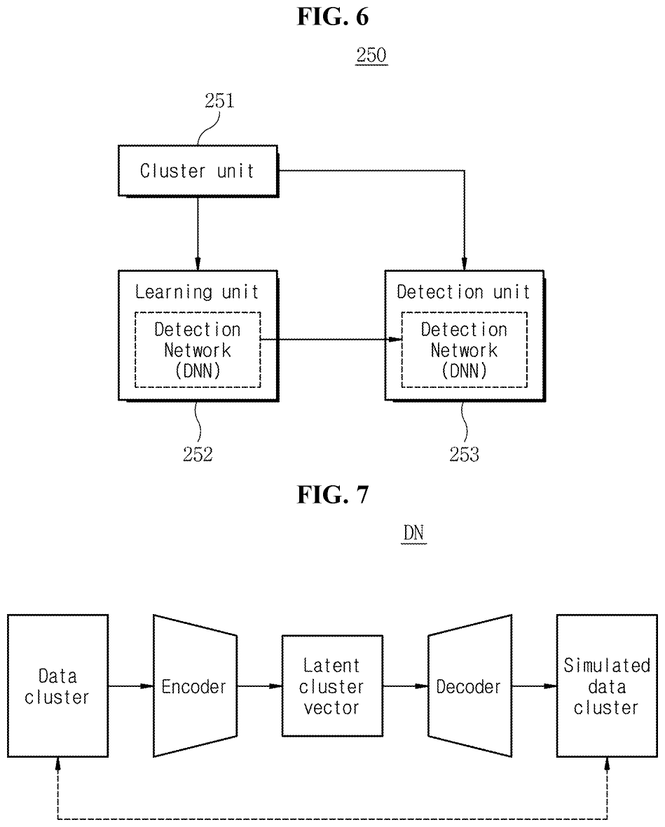

Now, a device for anomaly detection based on clustering according to another embodiment of the present invention will be described. FIG. 5 is a diagram illustrating the configuration of a device for anomaly detection based on clustering according to another embodiment of the present invention. FIG. 6 is a diagram illustrating the detailed configuration of a device for anomaly detection based on clustering according to another embodiment of the present invention. FIG. 7 is a diagram illustrating the configuration of a detection network for anomaly detection based on clustering according to another embodiment of the present invention.

Referring to FIG. 5, a device 200 for anomaly detection based on clustering according to another embodiment of the present invention (hereinafter referred to as ‘anomaly detection device’) includes a data collector 210, an input unit 220, a display 230, a storage 240, and a controller 250.

The data collector 210 is for collecting data. Here, the data may be a measurement value obtained by measuring a product produced in a production facility such as a smart factory through a certain sensor to determine whether the produced product is a good product or a defective product. Such data may be, for example, length, weight, shape, degree of withstanding bending or impact, degree of withstanding pressure, elasticity, etc. The data collector 210 may store the collected data in the storage 240 under the control of the controller 250.

The input unit 220 receives a user's key manipulation to control the anomaly detection device 200, generates an input signal, and transmits it to the controller 250. The input unit 220 may include one of a power key for powering on/off, a numeric key, and an arrow key, and may be formed as a predetermined function key on one side of the anomaly detection device 100. In the case where the display 230 is formed of a touch screen, the functions of various keys of the input unit 220 may be performed by the display 230, and if all functions can be performed only with a touch screen, the input unit 220 may be omitted.

The display 230 is for screen display and may visually provide a menu of the anomaly detection device 200, input data, function setting information, and any other information to the user. The display 230 may be formed of a liquid crystal display (LCD), an organic light emitting diode (OLED), an active matrix organic light emitting diode (AMOLED), or the like. Meanwhile, the display 230 may be implemented with a touch screen. In this case, the display 230 includes a touch sensor. The touch sensor detects a user's touch input. The touch sensor may be formed of a touch sensitive sensor of a capacitive overlay type, a pressure type, a resistive overlay type, or an infrared beam type, or may be formed of a pressure sensitive sensor. In addition to the above sensors, all types of sensor devices capable of detecting contact or pressure of an object may be used as the touch sensor of the present invention. The touch sensor may sense a user's touch input, generate a sensing signal including input coordinates indicating a touched location, and transmit it to the controller 250.

The storage 240 serves to store programs and data necessary for the operation of the anomaly detection device 200, and may be divided into a program region and a data region. The program region may store programs for controlling the overall operation of the anomaly detection device 200, an operating system (OS) for booting the anomaly detection device 200, applications, and the like. The data region may store data generated according to the use and operation of the anomaly detection device 200. In particular, data collected by the data collector 210 may be stored. Various kinds of data stored in the storage 240 may be deleted, modified, or added.

The controller 250 controls the overall operation of the anomaly detection device 200 and a signal flow between internal blocks of the anomaly detection device 200, and may perform a data processing function to process data. Basically, the controller 250 controls various functions of the anomaly detection device 200. The controller 250 may include, for example, a central processing unit (CPU), a digital signal processor (DSP), or the like.

Referring to FIG. 6, the controller 250 includes a cluster unit 251, a learning unit 252, and a detection unit 253.

The cluster unit 251 creates a data cluster by clustering data. The cluster unit 251 creates the data cluster using a predetermined first number (N) of data. In addition, when an anomaly detection process for the created data cluster is terminated, the cluster unit 251 erases a predetermined second number (M) of data from the existing data cluster in a first in first out (FIFO) scheme, and then creates a new data cluster using the first number (N) of data including new data added to data not erased from the existing data cluster.

The learning unit 252 is for training a detection network (DN) that creates a simulated data cluster by simulating a data cluster. Basically, the detection network (DN) is a type of artificial neural network (ANN). According to one embodiment, the detection network (DN) may be a graph neural network (GNN) model. The detection network (DN) may be a graph auto-encoder model that compresses an input with a low dimension and then restores it with a high dimension. The detection network (DN) may optionally add an attention-mechanism to form a graph attentional auto-encoder model. According to another embodiment, the detection network (DN) may be a model that includes a generative network such as an auto-encoder or a generative adversarial network (GAN), rather than a GNN model.

FIG. 7 shows the detection network (DN) according to an embodiment. The detection network (DN) compresses an input with a low dimension and then restores it with a high dimension. As shown, the detection network (DN) includes an encoder and a decoder. The encoder may create a potential cluster vector by performing a plurality of operations in which weights between multiple layers are applied to the data cluster, and the decoder of the detection network (DN) may create a simulated data clusters by performing a plurality of operations in which weights between multiple layers are applied to the potential cluster vector.

The detection unit 253 detects anomaly or not for the data cluster by using the detection network (DN). The detection unit 253 inputs the data cluster into the detection network (DN), and causes the detection network (DN) to reconstruct the data cluster and thereby create a simulated data cluster that simulates the data cluster. Then, the detection unit 253 determines whether a difference between the simulated data cluster and the data cluster is equal to or more than a predetermined threshold. If the difference is equal to or more than the predetermined threshold, it is determined that there is an anomaly in the data cluster, and if the difference is less than the predetermined threshold, it is determined that there is no anomaly in the data cluster.

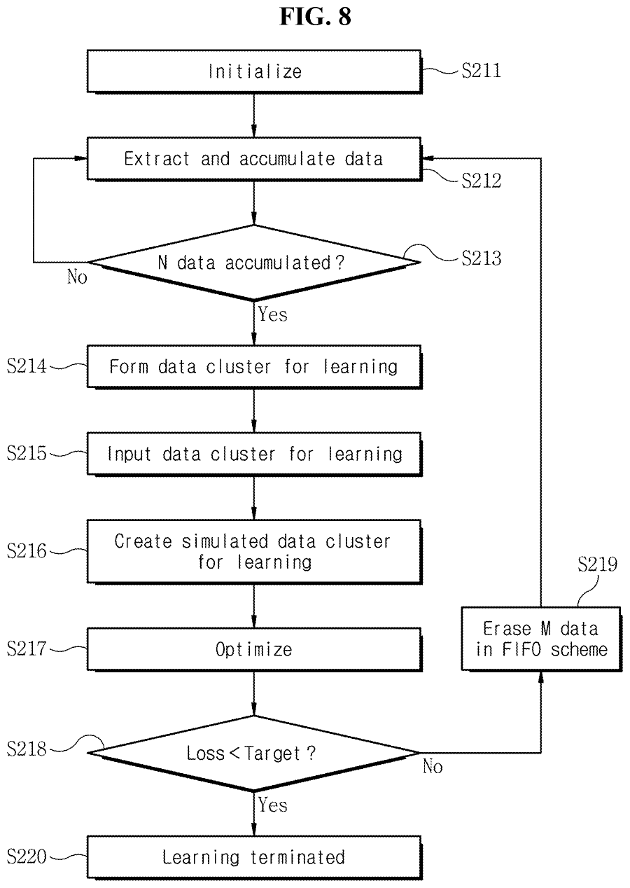

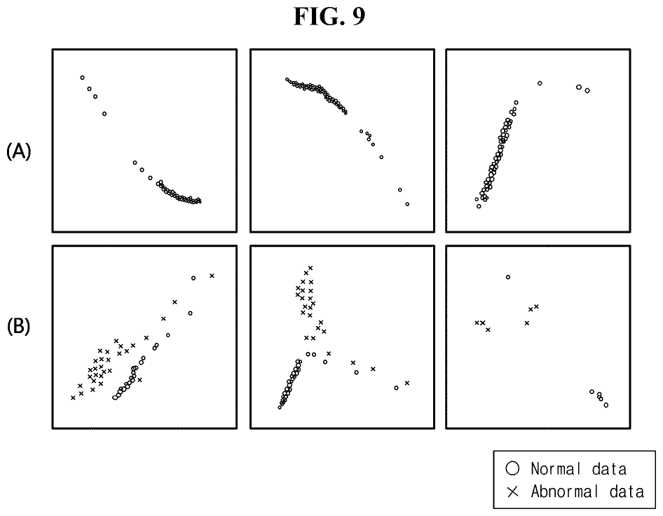

Next, a method for anomaly detection based on clustering according to an embodiment of the present invention will be described. According to an embodiment of the present invention, a detection network (DN) is used for anomaly detection. Now, a method for training the detection network (DN) will be described. FIG. 8 is a flowchart illustrating a method for training a detection network for anomaly detection based on clustering according to another embodiment of the present invention. FIG. 9 is a diagram illustrating clustering data for training a detection network for anomaly detection based on clustering according to another embodiment of the present invention.

In the embodiment of FIG. 8, it is assumed that the data collector 210 collects data that is a measurement value obtained by measuring a product produced in a production facility such as a smart factory through a certain sensor to determine whether the produced product is a good product or a defective product, and stores it in the storage 240. Here, the data may be, for example, length, weight, shape, degree of withstanding bending or impact, degree of withstanding pressure, elasticity, etc.

Referring to FIG. 8, in step S211, the learning unit 252 initializes a parameter, i.e., a weight (w), of the detection network (DN). For initialization, the Xavier initializer may be used.

Next, in step S212, the cluster unit 251 sequentially extracts and accumulates the data stored in the storage 240. Then, in step S213, the cluster unit 251 determines whether a predetermined first number (N) of data are accumulatively extracted.

If it is determined in step S213 that data less than the predetermined first number (N) are accumulated, steps S212 and S213 described above are repeated. On the other hand, if it is determined in step S213 that the predetermined first number (N) of data are accumulatively extracted, the predetermined first number (N) of data are clustered to form a data cluster for learning in step S214.

An example of a data cluster used as such a data cluster for learning is shown in FIG. 9. Three data clusters shown in (A) of FIG. 9 represent data clusters composed of only normal data, and data clusters shown in (B) of FIG. 9 represent data clusters in which abnormal data are mixed. During learning, the data included in the data cluster for learning is not assigned information on whether it is normal or not. In other words, the data collected by the data collector 210 includes normal data whose measurement value indicates a good product, and abnormal data whose measurement value indicates a defective product. However, the number of abnormal data included in the data cluster for learning is less than a predetermined ratio (ab) to the number of normal data included in the data cluster for learning. Here, the predetermined ratio (ab) refers to the number of abnormal data that can be ignored because there are an overwhelming amount of normal data. In other words, because there is so much normal data that it cannot be compared to abnormal data, all data are used for learning regardless of whether they are normal or abnormal. Unsupervised learning is possible because it is more advantageous to overcome the loss of normal data than to overcome the loss of a small amount of abnormal data during the learning process.

Next, in step S215, the learning unit 252 inputs the data cluster for learning into the detection network (DN). Then, in step S216, the detection network (DN) reconstructs the data cluster for learning through a plurality of operations in which weights between multiple layers are applied, and thereby creates a simulated data cluster for learning that simulates the data cluster for learning.

According to an embodiment, the encoder of the detection network (DN) creates a latent cluster vector for learning by performing a plurality of operations in which weights between multiple layers are applied to the data cluster for learning, and the decoder of the detection network (DN) creates a simulated data cluster for learning by performing a plurality of operations in which weights between multiple layers are applied to the latent cluster vector for learning.

Then, in step S217, the learning unit 252 calculates a loss representing a difference between the simulated data cluster for learning and the data cluster for learning, and performs optimization to update the weight (w) of the detection network (DN) through a backpropagation algorithm to minimize the loss.

Next, in step S218, the learning unit 252 determines whether the calculated loss is less than a predetermined target value. If it is determined in step S218 that the loss is not less than the target value, step S219 is performed. In step S219, the cluster unit 251 erases a predetermined second number (M) of data from the data cluster for learning. At this time, the cluster unit 251 erases the second number (M) of first extracted data among the data included in the cluster for learning in a first in first out (FIFO) scheme according to the order in which the data was extracted in step S212. Then, steps S212 to S218 described above are repeated. On the other hand, if it is determined in step S218 that the loss is less than the target value, learning is terminated in step S220. This means that the learning in steps S212 to S217 described above is repeated using a plurality of different data clusters for learning.

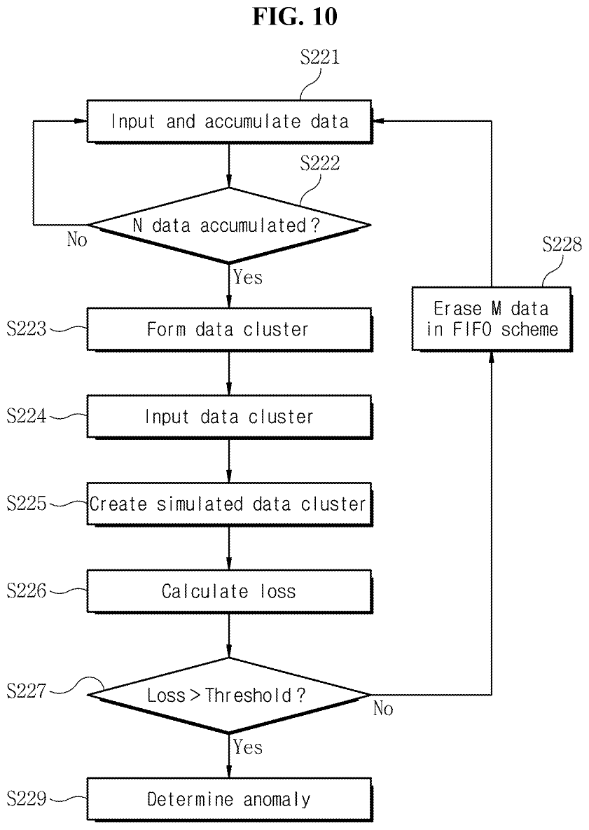

When learning about the detection network (DN) is completed as described above, the detection network (DN) is provided to the detection unit 253, and the detection unit 253 is capable of determining by using the detection network (DN) whether there is an anomaly in data. This method will be described. FIG. 10 is a flowchart illustrating a method for anomaly detection based on clustering according to another embodiment of the present invention.

Referring to FIG. 10, in step S221, the cluster unit 251 continuously receives, as an input from the data collector 210, data which is a measurement value obtained by measuring a produced product through a certain sensor in order to determine whether the product is good or defective. Then, in step S222, the cluster unit 251 determines whether the number of input data has accumulated to a predetermined first number (N).

If it is determined in step S222 that data less than the predetermined first number (N) are accumulated, steps S221 and S222 described above are repeated. On the other hand, if it is determined in step S222 that the predetermined first number (N) of data are accumulated, the cluster unit 251 forms a data cluster by clustering the accumulated first number (N) of data in step S223.

Whenever the data cluster is formed, the detection unit 253 inputs the data cluster into the detection network (DN) in step S224. Then, in step S225, the detection network (DN) reconstructs the data cluster through a plurality of operations in which weights between multiple layers are applied, and thereby creates a simulated data cluster that simulates the data cluster.

According to an embodiment, the encoder of the detection network (DN) creates a latent cluster vector by performing a plurality of operations in which weights between multiple layers are applied to the data cluster, and the decoder of the detection network (DN) creates a simulated data cluster by performing a plurality of operations in which weights between multiple layers are applied to the latent cluster vector.

Then, in step S226, the detection unit 253 calculates a loss representing a difference between the simulated data cluster and the data cluster. Thereafter, in step S227, the detection unit 253 determines whether the loss is equal to or greater than a predetermined threshold.

If it is determined in step S227 that the loss is less than the predetermined threshold, step S228 is performed. In step S228, the cluster unit 251 erases a predetermined second number (M) of data from the data cluster. At this time, the cluster unit 251 erases the second number (M) of data extracted first among the data included in the cluster for learning in a first in first out (FIFO) scheme according to the order in which the data was input in step S221. Then, it returns to step S221 again. Therefore, the cluster unit 251 continuously receives data as an input from the data collector 210 in step S221, and determines in step S222 whether the number of input data, including data previously not erased in step S228, has accumulated to the predetermined first number (N). If the predetermined first number (N) of data are accumulated including the non-erased data and newly accumulated data, the cluster unit 251 forms a data cluster by clustering the predetermined first number (N) of data accumulated in step S221, and repeats the above-described subsequent steps S223 to S227.

On the other hand, if it is determined in step S227 that the loss is equal to or greater than the predetermined threshold, step S229 is performed. Thus, in step S229, the detection unit 253 determines that there is an anomaly in the corresponding data cluster. This means that the data cluster contains a non-negligible number of abnormal data.

In the case of manufacturers, analysis of production conditions is necessary in an effort to improve yield. If there is a model that classifies the production conditions for good and defective products, it is possible to stop production and repair the equipment or environment in situations where production conditions for defective products occur. However, in order to build such a model, there is the inconvenience of having to perform a total inspection and labeling for production conditions. The present invention can construct a specific cluster using data (production conditions, production results, etc.) generated during production and automatically perform anomaly detection in the cluster. The anomaly detection method is based on determining an abnormal situation when production data that deviates from the normal range within the cluster is included. Applying this not only to manufacturing, but also to various situations where traceability is low due to too much data, etc. can achieve the same effect.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

Specific embodiments of the subject matter have been described in the disclosure. Other embodiments are within the scope of the following claims. For example, the operations recited in the claims can be performed in a different order and still achieve desirable results. As an example, the process depicted in the accompanying drawings does not necessarily require the depicted order or sequential order to achieve desirable results. In certain implementations, multitasking and parallel processing may be advantageous.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

What is claimed is:

1. A method for performing labeling, the method comprising:
by a cluster unit, upon receiving a plurality of input data, forming a plurality of nodes by mapping the plurality of input data into a predetermined vector space;
by the cluster unit, creating a cluster by clustering the plurality of nodes;
by a label processor, deriving one or more connected components by performing connected component analysis on the created cluster; and
by the label processor, performing labeling on the connected components.

2. The method of claim 1, wherein creating the cluster by clustering the plurality of nodes includes:
by the cluster unit, calculating a node value of a node in the cluster and an edge value indicating a distance or correlation between one node and another node.

3. The method of claim 1, wherein performing labeling on the connected components includes:
by the label processor, determining a label for the connected component based on an average of edge values between the plurality of nodes included in the connected component.

4. The method of claim 3, wherein determining the label includes:
in case where the edge value represents a distance between nodes in the vector space, by the label processor, assigning the label of the connected component with a lowest average of edge values between the nodes included in the connected component as normal.

5. The method of claim 3, wherein determining the label includes:
in case where the edge value represents a correlation between nodes in the vector space, by the label processor, assigning the label of the connected component with a highest average of edge values between the nodes included in the connected component as normal.

6. A device for performing labeling, the device comprising:
a cluster unit, upon receiving a plurality of input data, forming a plurality of nodes by mapping the plurality of input data into a predetermined vector space, and creating a cluster by clustering the plurality of nodes; and
a label processor deriving one or more connected components by performing connected component analysis on the created cluster, and performing labeling on the connected components.

7. The device of claim 6, wherein the cluster unit calculates a node value of a node in the cluster and an edge value indicating a distance or correlation between one node and another node.

8. The device of claim 6, wherein the label processor determines a label for the connected component based on an average of edge values between the plurality of nodes included in the connected component.

9. The device of claim 8, wherein in case where the edge value represents a distance between nodes in the vector space, the label processor assigns the label of the connected component with a lowest average of edge values between the nodes included in the connected component as normal.

10. The device of claim 8, wherein in case where the edge value represents a correlation between nodes in the vector space, the label processor assigns the label of the connected component with a highest average of edge values between the nodes included in the connected component as normal.

11. A method for anomaly detection, the method comprising:
by a cluster unit, creating a data cluster by clustering accumulated data whenever a predetermined first number of input data are accumulated;
by a detection unit, inputting the data cluster into a detection network trained to simulate the data cluster;
when the detection network reconstructs the data cluster and creates a simulated data cluster simulating the data cluster, by the detection unit, determining whether a difference between the simulated data cluster and the input data cluster is greater than or equal to a predetermined threshold; and
upon determining that the difference is greater than or equal to the predetermined threshold, determining that there is an anomaly in the input data cluster.

12. The method of claim 11, further comprising:
upon determining that the difference is less than the predetermined threshold,
by the cluster unit, erasing a predetermined second number of data from the data cluster;
by the cluster unit, creating a new data cluster by accumulating newly input data into the data cluster from which the predetermined second number of data are erased; and
by the detection unit, detecting an anomaly in the new created data cluster by using the detection network.

13. The method of claim 11, further comprising:
before creating the data cluster,
by the cluster unit, creating a data cluster for learning by accumulating a predetermined first number of data and clustering the accumulated data;
by a learning unit, inputting the data cluster for learning into an unlearned detection network;
by the detection network, reconstructing the data cluster for learning and thereby creating a simulated data cluster for learning that simulates the data cluster for learning; and
by the learning unit, performing optimization to update a parameter of the detection network so that a difference between the simulated data cluster for learning and the input data cluster for learning is minimized.

14. The method of claim 13, wherein data contained in the data cluster for learning includes normal data and abnormal data, and
the number of abnormal data included in the data cluster for learning is less than a predetermined ratio (ab) to the number of normal data included in the data cluster for learning.

15. A device for anomaly detection, the device comprising:
a cluster unit creating a data cluster by clustering accumulated data whenever a predetermined first number of input data are accumulated; and
a detection unit inputting the data cluster into a detection network trained to simulate the data cluster, when the detection network reconstructs the data cluster and creates a simulated data cluster simulating the data cluster, determining whether a difference between the simulated data cluster and the input data cluster is greater than or equal to a predetermined threshold, and upon determining that the difference is greater than or equal to the predetermined threshold, determining that there is an anomaly in the input data cluster.

16. The device of claim 15, wherein the cluster unit erases a predetermined second number of data from the data cluster upon determining that the difference is less than the predetermined threshold, and creates a new data cluster by accumulating newly input data into the data cluster from which the predetermined second number of data are erased, and
the detection unit detects an anomaly in the new created data cluster by using the detection network.

17. The device of claim 15, further comprising:
a learning unit inputting, when the cluster unit creates a data cluster for learning by accumulating a predetermined first number of data and clustering the accumulated data, the data cluster for learning into an unlearned detection network, and
performing, when the detection network reconstructs the data cluster for learning and thereby creates a simulated data cluster for learning that simulates the data cluster for learning, optimization to update a parameter of the detection network so that a difference between the simulated data cluster for learning and the input data cluster for learning is minimized.

18. The device of claim 17, wherein data contained in the data cluster for learning includes normal data and abnormal data, and
the number of abnormal data included in the data cluster for learning is less than a predetermined ratio (ab) to the number of normal data included in the data cluster for learning.
